(19) United States
(12) Patent Application Publication
(10) Pub. No.: US 2008/0216129 A1
(43) Pub. Date: Sep. 4, 2008

(54) Method and system for providing data from audio/visual source devices to audio/visual sink devices in a network

(75) Inventor: John W. Chaney, Gilroy, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/827,307

(22) Filed: Jul. 11, 2007

Related U.S. Application Data
(60) Provisional application No. 60/904,657, filed on Mar. 2, 2007.

(51) Int. Cl. H04N 7/18

(52) U.S. Cl. 725/74

(57) ABSTRACT

A method and system for providing data from one or more audio/visual (A/V) source devices to one or more A/V sink devices in a network is provided. The system implements a rendering method in a video rendering module configured to render display data related to digital videos from an A/V source device to one or more sink devices across the network. The video rendering module includes a presentation module configured to obtain selected display data from one or more of the A/V source devices across the network, and a navigation module configured to control the presentation module for obtaining the selected display data, and to allow one or more users to navigate through the display data to access the digital videos.

### RELATED APPLICATION

This application claims priority from U.S. Provisional Patent Application Ser. No. 60/904,657, filed Mar. 2, 2007, incorporated herein by reference.

### FIELD OF THE INVENTION

The present invention relates to audio/visual (A/V) networks, and in particular to connecting an A/V source device to an A/V sink device in a home network.

### BACKGROUND OF THE INVENTION

With the proliferation of A/V information in networks such as local area networks, many users' desire freedom and efficiency in connecting A/V source devices such as digital video disc (DVD) players to A/V sink devices such as televisions (TVs) in their networks. However, a conventional DVD player only plays videos to a TV set that is connected directly to the DVD player by, e.g., analog and/or digital visual interface (DVI), high-definition multimedia interface (HDMI) connection, etc.

FIG. 1 is a block diagram for a conventional home entertainment system 100 including a DVD player 101 (source), a DVD disk 102, a TV 106 (sink) and an audio device 108 (sink). The video monitor 106 may be a conventional TV, a digital TV, a computer display, a projector, a high-definition TV (HDTV), etc.

The DVD disk 102 contains presentation data 102a, e.g., A/V content, and related display data 102b. The A/V contents 102a on the DVD disk 102, as well as the display data 102b such as the metadata (e.g., the data describing the structure and workings of A/V data), sub-pictures, titles and subtitles, textual biographical information of the actors and producers, and navigation menus, etc., are rendered locally from the DVD player 101 to the TV set 106 via the direct connection.

Specifically, as commanded by a remote control device 109, a navigation manager (NM) 104 for the DVD player 101 receives the display data 102b from the DVD disk 102. Further, the NM 104 controls a presentation engine (PE) 103 for the DVD player 101 to receive selected A/V content including the presentation data 102a from the DVD disk 102. The presentation data 102a provides A/V Program Elementary Stream (PES) data, wherein selection of the PES data to be received from the disk 102 by the PE 103 is controlled by the NM 104. The PES data is packetized in variable-length packets. The PE 103 then sends the PES data through a video decoder 105 (e.g., an MPEG2 decoder) for display as video content on a video monitor 106.

In addition to the A/V content, the NM 104 determines which still pictures (i.e., sub-pictures) and menu graphics from the DVD disk 102 should be blended with the decoded video output from the video decoder 105 for display on the video monitor 106. Through the menu graphics, a user can browse and select various contents from the DVD disk 102. Audio content from the DVD disk 102 may also be sent by the PE 103 separately through an audio decoder 107 to an audio device 108 such as stereo speakers. In addition to playing the A/V content, display data 102 may be displayed on the video monitor 106 as overlays on the video images.

The DVD player 203 may provide video to the remotely connected HDTV 205 via a 1394 connection 210. Using the connection 210 the HDTV only has access to the primary video stream of the DVD player 202. A user interface is not implemented or rendered on the HDTV 205. Nor is the HDTV equipped to receive and process the metadata and render the OSD of the DVD. The PES A/V content of the primary video stream of DVD 202 is encapsulated into the MPEG2 System Level Transport (MP2SLT) and is sent via a 1394 connection to the remote HDTV 205. Some primitive CEA-931-C commands such as pause, stop, play, etc., are allowed to be passed through the 1394 connection from the HDTV 205 to the DVD player 202, but the graphics which are part of the DVD disk in 202 are not rendered on the HDTV 205. As such, playing a DVD remotely is more limited than playing the DVD content using the DVD remote control navigation and the direct monitor connection as in FIG. 1.

However, in such a conventional home entertainment system, content from the DVD player 101 is only available to the directly connected (i.e., local) video monitor 106. The Digital Living Network Alliance (DLNA) standard attempts to address such a problem by providing an environment for sharing digital media and content among different devices such as PCs, TVs, mobile devices, etc. All the different types of devices connected to the network are identified based on their IP addresses. Thus, a home network is treated as a miniature Internet. However, the DLNA attempts to handle all data types within a DLNA network. This is disadvantageous since entertainment content including A/V data has different networking needs than other types of data such as computer data, which require different networks to fully meet their different needs.

The High-definition Audio-video Network Alliance (HANA) standard is focused on home entertainment networks, for handling A/V content. The HANA standard allows for remote control of every device within the home network with IEEE 1394 (FireWire) connectivity. This can be achieved through the built-in FireWire ports of devices, or by adding a module to existing devices. The IEEE 1394 connections allow for transport of multiple, simultaneous high-definition (HD) data streams, and enable the network to operate on a peer-to-peer configuration (e.g., each device is recognized as a network device and can recognize any other devices in the network). In addition, the 1394 connections allow both isochronous and asynchronous transmission of data.

FIG. 2 shows an example conventional IEEE 1394 home network 200 including DVD players 202, 203, HDTVs 204, 205 and a receiver 206. Each DVD player is directly (locally) connected to a corresponding HDTV using a cable 207. The DVD player 202 can be connected to the HDTV 204 and the receiver 206 using many different types of connections including: (1) Composite video RCA jack into the HDTV 204 and R/L-stereo RCA jacks into the HDTV 204 or the audio receiver 206; (2) S-video into the HDTV 204 and a Sony/Philips Digital Interface Format (SPDIF) cable 208 into the receiver 206; (3) HDMI into the HDTV 204; (4) HDMI into the HDTV 204 and SPDIF into the AV receiver 206, etc. In particular, the HDMI specification allows transfer of uncompressed HD signals between devices via a coaxial cable. The HDMI interface is provided in many consumer electronics devices for transfer of digital A/V information between devices. The DVD player 203 can be connected to the HDTV 205 using similar connections as that between the DVD player 202 and the HDTV 204. The HDTVs 204 and 205 are connected to the 1394 bus 209, but the DVD players 202 and 203 are only directly connected to the HDTVs 204 and 205, respectively.

There is, therefore, a need for a method and system for connecting A/V devices in a network, and providing data from one or more source devices to one or more sink devices across the network.

### BRIEF SUMMARY OF THE INVENTION

The present invention provides a system and method for providing A/V data from one or more source devices to one or more sink devices across a network such as a home network. In one embodiment, the present invention provides a video rendering module configured to render display data related to digital videos from an A/V source device to one or more sink devices across the network. The video rendering module includes a presentation module configured to obtain selected display data from one or more of the A/V source devices across the network, and a navigation module configured to control the presentation module for obtaining the selected display data, and to allow one or more users to navigate through the display data to access the digital videos.

In another embodiment, the present invention provides a network including A/V electronic devices such as a video monitor, a digital video source containing both A/V content and display data related to the A/V content, and a digital video rendering module configured to render the display data from the digital video source on the video monitor. The digital video rendering module includes a presentation module configured to obtain selected display data from the digital video source across the network, and a navigation module configured to control the presentation module for obtaining the selected display data, and to allow a user to navigate through the display data to access the A/V content.

In another aspect, the present invention provides a method of distributing one or more programs from a digital video source to one or more sink devices in a network, wherein each of the one or more programs includes A/V content and display data. The method includes obtaining the A/V content from the digital video source across the network, and obtaining the display data from the digital video source across the network separately from the A/V content. A plurality of users can access one or more digital videos and their related display data simultaneously across the network.

These and other features, aspects and advantages of the present invention will become understood with reference to the following description, appended claims and accompanying figures.

### BRIEF DESCRIPTION OF THE DRAWINGS

FIG. 1 shows an example of a conventional home entertainment system.

FIG. 2 shows an example of a conventional IEEE 1394 home network.

FIG. 3A shows a functional block diagram of a home network, according to an embodiment of the present invention.

FIG. 3B shows a mode detailed functional block diagram of the home network in FIG. 3A, according to an embodiment of the present invention.

FIG. 4 is a flowchart showing a method of rendering A/V content and related display data separately across a network, in accordance with an embodiment of the invention.

FIG. 5 is a flowchart showing steps performed by the DVDR in accordance with an embodiment of the invention.

FIG. 6 shows a functional block diagram of a home network including a plurality of source devices and sink devices in accordance with an embodiment of the invention.

### DETAILED DESCRIPTION OF THE INVENTION

The present invention provides a method and system for connecting devices such as A/V devices in a local area network such as a home network. In one embodiment, the present invention provides a method and system for providing A/V data from a source device to one or more sink devices across a local area network such as a home network. As such multiple sink devices can access various content (e.g., A/V content and corresponding metadata) provided by one or more source devices, across the network. The present invention also allows different devices to simultaneously access different content in the network.

In one implementation, a rendering module is connected in the network, and is configured for providing various data (e.g., A/V content and corresponding metadata) from a source device (e.g., a DVD video source) to one or more sink devices (e.g., video monitors) across the network, according to the present invention.

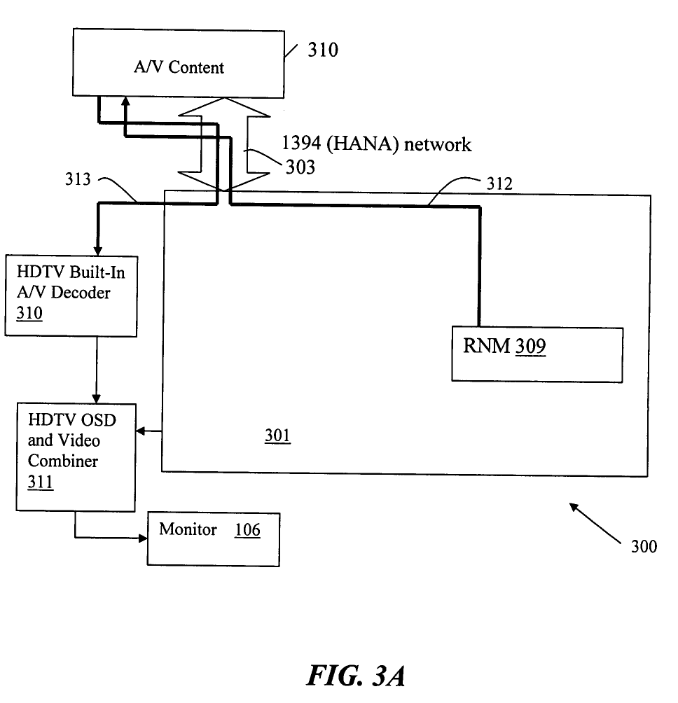

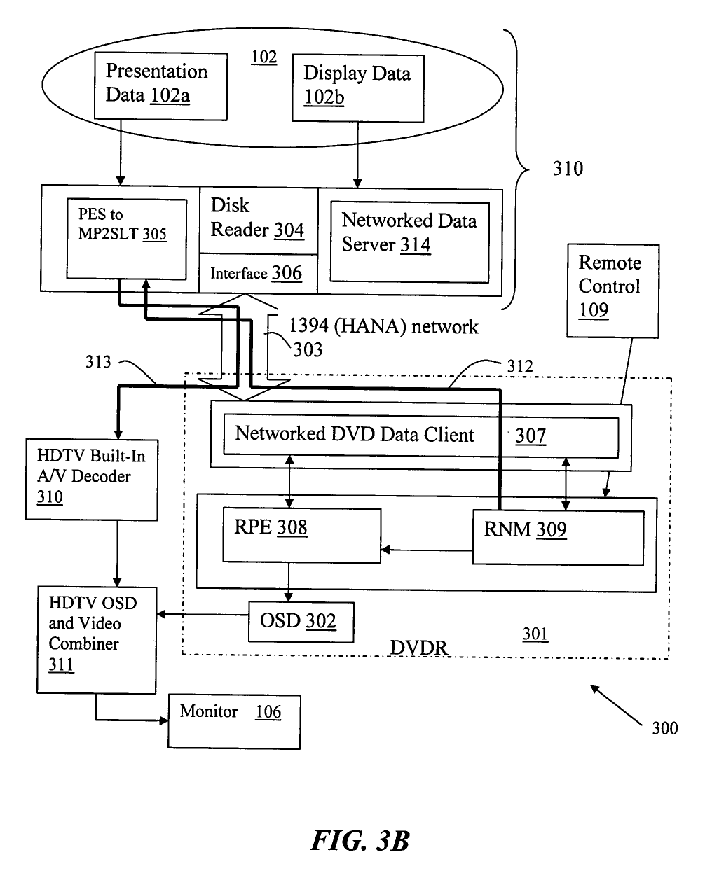

FIG. 3A shows a network 300 such as a home network in accordance with an embodiment of the invention. The network 300 includes a rendering module such as a DVD rendering module (DVDR) 301, a DVD system 310 and a video monitor 106. The network 300 also includes A/V decoders 310, an on screen display (OSD) and video combiner 311, which may all be implemented in an HDTV. The network 300 builds on the 1394 (HANA) network 303.

The DVDR 301 is configured for rendering various A/V content and corresponding metadata from a source device (e.g., a DVD video source) on one or more sink devices (e.g., video monitors) via the home network. The DVDR 301 enables generating an OSD 302 on any display device, such as the video monitor 106, across the network 300, as described in more detail further below. The DVD system 310 is connected to, and communicates with the DVDR 301 via the IEEE 1394 network 303 implementing HANA. The video monitor 106 is also connected to the DVDR 301 via the network 303.

Display data from the DVD system 310 goes through a channel 312, unaltered. It is in a non-rendered state. A remote navigation module (RNM) 309 selects the A/V content to transmit to the HDTV built-in A/V decoder 310 via an isochronous channel 313 of the network 303. Such commands from the RNM 309 are sent to the system 310 via an asynchronous channel 312 in the 1394 network 303, and thus do not interfere with the A/V content transmission through the isochronous channel 313. The system 310 (server) sends over the channel 313 the compressed video to the decoder function of the remote device 106. The remote device renders the display data as an OSD and superimposes that image on a fully decoded processed MP2SLT to render the complete video image on the remote device display. The sink for the A/V is the remote client decoder input.

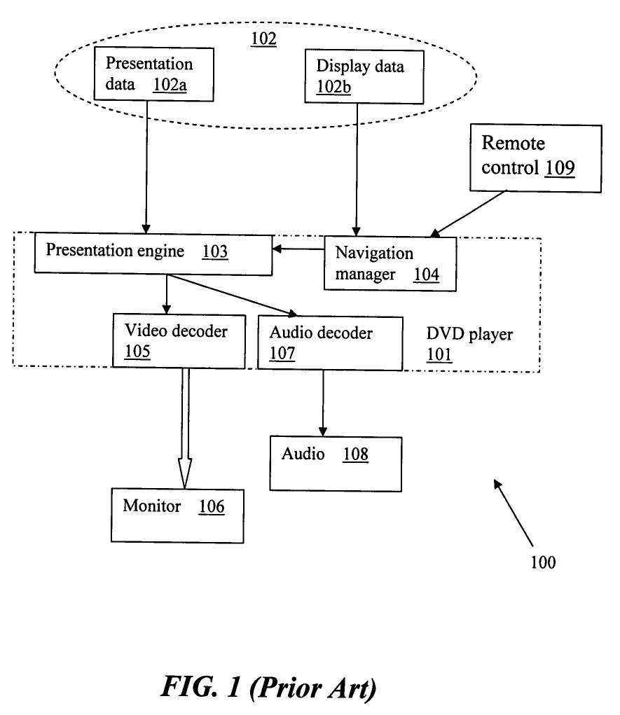

FIG. 3B shows a more detailed view of the network 300 such as a home network in accordance with an embodiment of the invention. A disk reader 304 in the DVD system 310 accesses the DVD disk 102 therein, wherein as mentioned the DVD disk includes presentation data 102a and corresponding display data (including navigation data) 102b. Unlike the conventional DVD player 101 in FIG. 1, the DVD system 310 in FIG. 3B in accordance with an embodiment of the invention does not require audio and video decoders. Instead, any available MPEG decoder 310 in the network 300 (such as a built-in MPEG decoder in an existing HDTV which satisfies the FCC tuner mandate requirements) can be used.

A PES to MP2SLT module 305 receives presentation data 102a from the DVD disk 102 as a PES stream, and repackages the PES stream into a packet stream. One or more PES streams are repackaged into a constant-length (e.g., 188-byte per packet) packet stream, MP2SLT. The MP2SLT stream is a multiplexed stream of one or more compressed video programs. The MP2SLT stream is usually on the order of 20 Mbps (megabits per second) when carried as content for Advanced Television Systems Committee (ATSC) off-air broadcasts. In general, an upper limit on the bandwidth is not defined for MP2SLT streams.

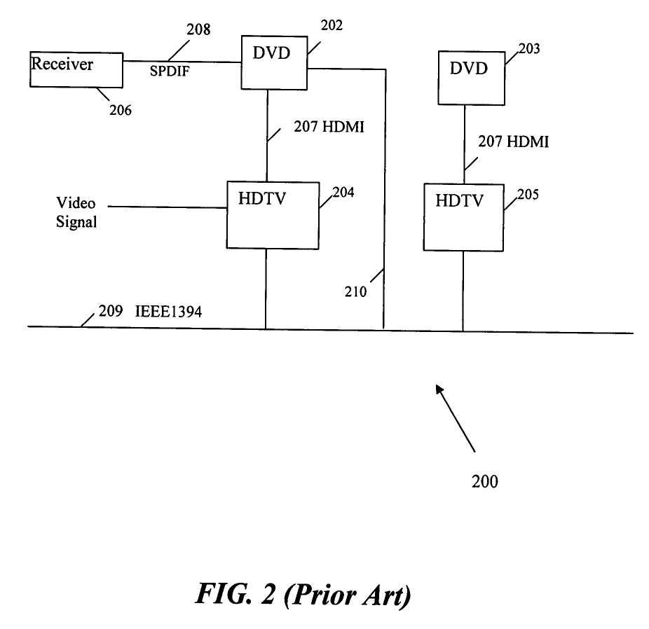

The PES to MP2SLT module 305 may be realized through software. For example, a single 300 MHz MIPS CPU can perform two PES-to-MP2SLT processes simultaneously. Thus, the module 305 is easily scalable for various numbers of DVD systems 310 and the DVDR 301. A 1394 interface chip 306 (e.g., Texas Instrument 1394 link layer) is used to interface the disk reader 304 with the 1394 (HANA) network 303. It is recognizable to those of ordinary skill in the art that because a HANA network is a peer-to-peer network, a data bus is not required. Rather, each device in the network 300 connected according to the HANA standard, may transmit data to any other device in the network. However, a 1394 bus similar to that in FIG. 2 can still be included for some connections in the network 300.

The DVDR 301 includes a networked DVD data client 307, a presentation module such as a remote presentation engine (RPE) 308, and a navigation module such as a remote navigation module (RNM) 309. The DVDR 301 receives a command from a user via a remote control device 109. Specifically, such commands are received via a DVD data client 307 for processing by the RNM 309 which then enables rendering of data (102a, 102b) from the DVD system 310 on the monitor 106.

The RNM 309 commands (controls) the PES to the MP2SLT module 305 in selecting which A/V content to transmit to the HDTV built-in A/V decoder 310 via an isochronous channel 313 of the network 303. Such commands from the RNM 309 are sent to the module 305 via an asynchronous channel 312 in the 1394 network 303 through the networked DVD data client 307, and thus do not interfere with the A/V content transmission through the isochronous channel 313.

Although the isochronous channel 313 as shown in FIG. 3B is implemented through the 1394 network 303 only, those of ordinary skill in the art will recognize that the isochronous channel 313 may also pass through the RPE 308 such that A/V content may be processed by the RPE 308 as needed. In this example, the A/V content is carried isochronously on 1394 connections in, e.g., 61883-4 format.

The RNM 309 also controls the RPE 308 to fetch display data 102b, such as navigation data and other data related to the A/V content (e.g., metadata), from the DVD disk 102. The fetched display data 102b is transmitted from the module 305 through the data client 307 to the RPE 308, also via the asynchronous channel 312. The RPE 308 generates an OSD 302 which presents the display data 102b, wherein the OSD 302 is sent to the combiner 311 through the network 303, or by other means such as direct connection, a 1394 bus, wirelessly, etc.

The combiner 311 combines the A/V content, transported as a MP2SLT stream through the channel 313 and decoded by the decoder 310, with the OSD 302, wherein the OSD 302 may be displayed together with video images on the video monitor 106.

The RNM 309 then enables the user to navigate (e.g., via remote controller 109) through such data including the navigation data 102b from the DVD disk 102, as if the user is accessing the DVD disk 102 locally (directly). Specifically, the DVDR 301 renders the menus and the navigation data (102b) from the DVD disk 102 in the DVD system 310 on the video monitor 106 across the network 303 (FIG. 3B), as though a conventional DVD player playing the DVD disk 102 is directly (locally) connected to the video monitor 106 (FIG. 1). All DVD disks and their contents may be stored in one DVD system 310 and are available to all video monitors (e.g., TVs) connected to the home network.

A content storage medium may be used for storing content, wherein the storage medium can be part of the source device 310, or as a standalone data server connected to the 1394 network 303. As shown by way of example in FIG. 3B, a networked data server 314 is used as part of the DVD system 310 to store a plurality of A/V programs and their display data. The data server 314 may comprise a hard disk drive (HDD), flash memory, optical storage, or other storage means. Although the exemplary configuration in FIG. 3B shows the data server 314 as part of the DVD system 310, those of ordinary skill in the art will recognize that the data server 314 can be located anywhere in the network.

The data server 314 can replace multiple DVD disks 102. For example, a 500 GB HDD can store about 125 standard-definition movies or 25 HD movies. Another advantage of using the data server 314 in place of DVD disks is the faster read rate. For example, a typical HDD read rate is about eight (8) times that of the optical read rate.

Data is stored in the data server 314 in the form of, for example, disk “images” exactly as if they were stored in the DVD disk 102, i.e., having exactly the same files and data structures (e.g., 102a, 102b) as those in the DVD disk 102. This is allowed under the DVD Copyright Control Association (DVD CCA) rules using the “move” operation. Accordingly, the PES to MP2SLT module 305 can process data from the data server 314 the same way as from the DVD disk 102.

For example, through the OSD 302, a top menu can be displayed on a video monitor 106 e.g. in the form of a Graphic User Interface (GUI). The top menu may include a list of movies stored in a data server 314. The user can browse all the movie titles listed in the top menu. In addition, the user can navigate through the top menu to access individual movies and their respective display. Thus, the user can watch movies while examining related information such as textual biographical information on the actors. Thus, through the DVDR 301 the user has access to one or more DVD disks 102 (and/or to a plurality of A/V programs including display data on a server 314), as if the user controls multiple DVD players locally and directly connected to the video monitor 106. The network 300 enables one or more users to access multiple videos and related information simultaneously.

The display data 102b goes through the channel 312. The display data goes through the PES to MP2SLT module 305. The display data is sent unaltered, and as it resides on disk. The PES to MP2SLT task in the server sends the channel 313 the compressed video to the decoder function of the remote device. The remote device renders the display data as an OSD and superimposes that image on the fully decoded processed MP2SLT to render the complete video image on the remote devices display. The sink for the A/V is the remote client decoder input. The RNM does determine which A/V stream is sent from the DVD disk.

The Networked DVD Data Client 307 is the single point of contact with the network (generally 1394) and directs requests to the server and distributes incoming data to the RPE and RNM. The Networked DVD Data Client 307 also allows a device to be advertised on the network as a client for DVD and other A/V Data source serving devices.

The OSD is remotely combined with the fully decoded video and rendered entirely in the remote client device. As such, it is sent, generally, by a hard-wired connection, without using the network connection such as 1394. It is possible that the OSD and decoded video could be combined (overlaid) in the server, but the result needs to be real-time encoded into MP2SLT to be sent across a network connection such as 1394. The present invention allows the utilization of optical or hard disk drive read capacity to play two or more independent views to two or more remote clients of the same DVD data from an optical drive or may play several different DVD data files stored on the same hard-disk drive. This is a scaling feature provided by this invention.

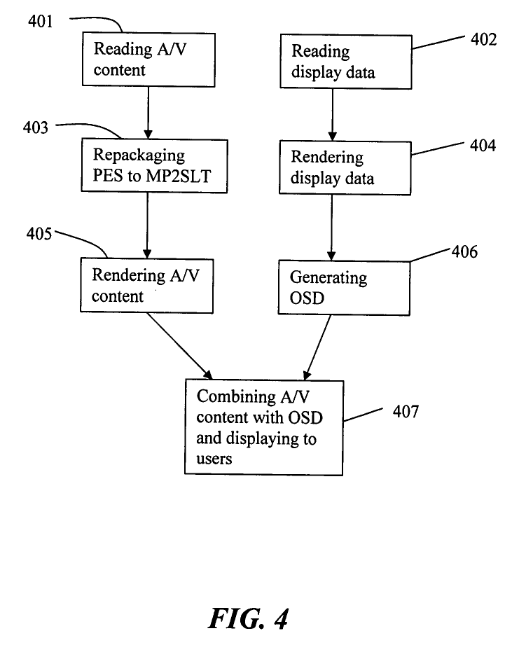

A method of rendering A/V content and display data in the network 300 (FIG. 3B) in accordance with an embodiment of the invention is summarized below with reference to the flowchart in FIG. 4. In steps 401 and 402, A/V content 102a and related display data 102b are read, respectively, from a digital video source. The digital video source may be a storage medium in which a plurality of programs are stored. The plurality of programs are previously “moved” as exact disk images from, e.g., DVD disks. It is noted that steps 401 and 402 may be executed in parallel, or sequentially. In step 403, the A/V content 102a is repackaged from a PES format to a MP2SLT packet stream, and in step 404 rendered across the network 303, e.g., isochronously. In step 404, the display data 102b is rendered through the network 303 separately, e.g., asynchronously. Based on the display data 102b, in step 406 the OSD is generated. In step 407, the A/V content and the OSD are combined and displayed on one or more display devices at various locations in the network 300. The users may remotely browse the content of, and select titles from, any of the digital video sources as if the digital video sources are connected locally to the users' video monitors.

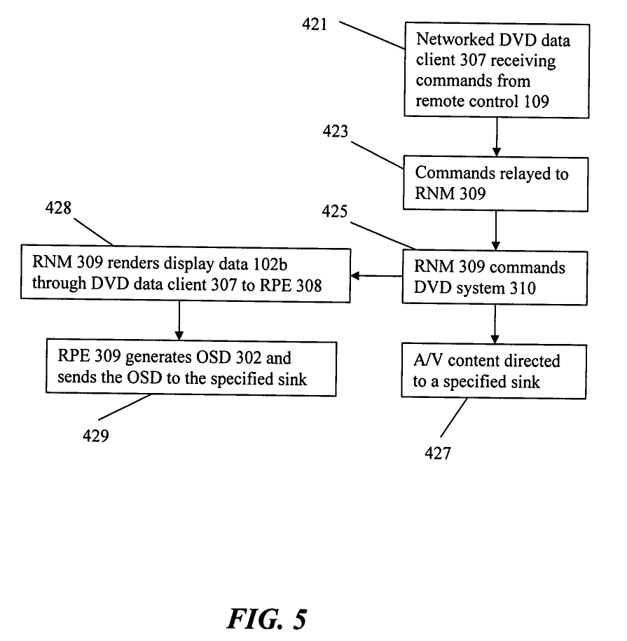

The steps performed by the DVDR 301 are further illustrated in detail in the flowchart of FIG. 5. In step 421, the networked DVD data client 307 receives commands from the remote control 109 as controlled by a user. In step 423, the commands are relayed to the RNM 309. In step 425, the RNM 309 sends corresponding commands to the DVD system 310, e.g., asynchronously, to direct certain A/V content to a sink device specified by the user or recognized by the remote control in step 427. In step 428, which may be parallel to step 427, RNM 309 renders display data 102b through the DVD data client 307 to the RPE 308. In step 429, the RPE generates the OSD 302 and sends the OSD to the specified sink device. The DVDR may be implemented, e.g., as software programs executing on a processor. In one example, the processor may be in a plug-in box for an HDTV, or may be already a part of the HDTV.

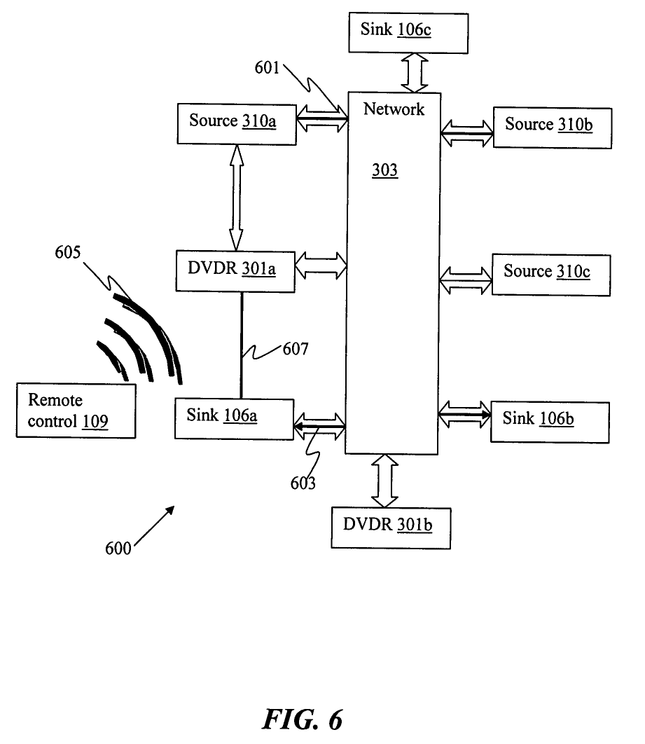

FIG. 6 shows another exemplary network 600 according to the present invention. The network 600 includes multiple source devices (310a, 310b, 310c), plural sink devices (106a, 106b, 106c) and one or more DVDR modules (301a, 301b), connected through a 1394 HANA network 303.

It is noted that although FIG. 6 by way of an example illustrates a centralized network 303, it is recognizable to those skilled in the art that as most or all of the devices are connected to each other through 1394 connections (shown as block arrows 601), and each device can work as a data relay for other devices, a centralized network structure is not necessary. Rather, most or all of the devices may be equal parts of the peer-to-peer network. However, it is also noted that the network 600 does not forbid other types of communications between devices, such as the wireless communication 605 and a direct, local connection (such as HDMI or coaxial cable) 607.

A user of the sink device 106a has access to all the data content in source devices 310a, 310b, and 310c connected to the network 303. The DVDR 301a allows a user of the sink device 106a to access all the data content in source devices 310a, 310b, and 310c connected to the network 303. Further, the DVDR 301a can simultaneously provide two sets of A/V programs together with their respective display data from source devices 310a, 310b through the network 303 to two sink devices 106a, 106b (e.g., video monitors), respectively. The DVDR 301b can provide similar functions as the DVDR 301a.

As such, the DVDR 301a and/or the DVDR 301b allow a single source device, such as a DVD system 310a, to separately provide one or more contents (e.g., movies or TV programs) over a home network to several sink devices such as devices 106a-106c. Users watching sink devices 106a-106c may simultaneously watch the same movie from, e.g., a source device 310a, or simultaneously watch different movies from the source device 310a or from any of the source devices 310a-310c.

Meanwhile, a user utilizing a sink device at any location within the network (e.g., a user watching any of the sink devices 106a-106c), can use the DVDR 301a or the DVDR 301b to navigate through all the data stored on any of the source devices 310a-310c. The user may control the selection of programs to be viewed as well as display data by, for example, using a remote control device 109 to communicate with the network 303 through one or more of the DVDR 301a and/or DVDR 301b. The remote control device 109 may communicate with the network 303 wirelessly or by other means known in the art. The user may specify one or more programs (indicated by arrows 601) to be delivered to a nearby screen such as that of the sink device 106a. The sink device 106a can display the programs in addition to navigation menus for the user to browse through all the programs available in the network.

Alternatives to 1394 are possible, such as wireless and Ethernet.

The aforementioned exemplary configurations according to the present invention can be implemented in many ways. For example, although the embodiments herein are described in the context of a home network, those skilled in the art will recognize that the present invention is useful with other networks as well. Further, although the network of the invention is illustrated based on a HANA network, those of ordinary skill in the art will recognize that the present invention is useful with other networks such as the DLNA networks. In addition, although the 1394 standard is shown in FIG. 3B for interfacing different devices, other types of interfaces and data transfer schemes may be used.

Furthermore, the present invention is not limited to “DVD” in its conventional meaning. Rather, high-definition DVD (HD DVD) and BluRay may be used in place of the DVD disk 102. In addition, MP2SLT is used as an exemplary method of stream data carrying in the embodiments of the invention. However, as those of ordinary skill in the art will recognize, particular methods of carrying are not important, although such methods need to be standardized to accommodate connectivity of various devices in the market. As such, other methods of stream data carrying can be utilized.

The present invention also allows connecting an HDTV remotely to a DVD player so that the entire OSD and control of the DVD is displayed on the remote HDTV and in such a way that one player may be able to service multiple independent plays of that DVD on several HDTVs within the Home Network. The method of play is easily scalable across the network for multiple connections. This additionally, enables the concept of a network connected DVD jukebox.

As is known to those skilled in the art, the aforementioned exemplary architectures in accordance with embodiments of the invention described above, can be implemented in many ways, such as program instructions for execution by a processor, as logic circuits, as an application-specific integrated circuit (ASIC), as firmware, as a digital signal processor (DSP) etc. The present invention has been described in considerable detail with reference to certain preferred versions thereof; however, other versions are possible. Therefore, the spirit and scope of the appended claims should not be limited to the description of the preferred versions contained herein.

What is claimed is:

1. An apparatus for providing data from one or more audio/visual (A/V) source devices to one or more A/V sink devices in a network, comprising:
a video rendering module configured to render display data related to A/V content from an A/V source device to one or more sink devices across the network;
the video rendering module comprising:
a presentation module configured to obtain selected display data from one or more of the A/V source devices in the network; and
a navigation module configured to control the presentation module for obtaining the selected display data, and to allow one or more users to navigate through the display data to access the A/V content.

2. The apparatus of claim 1, wherein:
the presentation module is further configured to generate a display on the one or more A/V source devices utilizing the selected display data; and
the navigation module is further configured to receive commands from a control device for the user to navigate through the display data to access one or more digital videos in the A/V content.

3. The apparatus of claim 1, wherein the display data comprise one or more of: metadata for the A/V content, sub-pictures, titles, subtitles, textual biographical information of the actors and producers, and navigation menus.

4. The apparatus of claim 1, wherein the one or more A/V source devices are connected to the video rendering module through the network.

5. The apparatus of claim 4, wherein the one or more A/V source devices are connected to the video rendering module using an IEEE 1394 connection.

6. The apparatus of claim 1, wherein the navigation module is configured to allow the user to navigate through the display data as commanded by a remote control device.

7. The apparatus of claim 1, wherein the network comprises a HANA home network.

8. The apparatus of claim 1, wherein:
the presentation module is further configured to generate an on screen display (OSD) utilizing the obtained selected display data on any of the one or more sink devices at any locations within the network; and
the navigation module is further configured to control the presentation module for obtaining the selected display data and for specifying one or more locations for the OSD and the digital video to be directed.

9. A network including audio/visual (A/V) electronic devices, comprising:
an A/V content source containing both A/V content and display data related to the A/V content; and
a rendering module configured to render the display data from the A/V content source and to generate a display on a video monitor, the rendering module comprising a presentation module configured to obtain selected display data from the A/V content source in the network.

10. The network of claim 9 wherein the rendering module further comprise a navigation module configured to control the presentation module for obtaining the selected display data, and to allow a user to navigate through the display data to access the A/V content.

11. The network of claim 10, wherein:
the presentation module is further configured to generate a display on the one or more A/V source devices utilizing the selected display data; and
the navigation module is further configured to receive commands from a control device for the user to navigate through the display data to access the A/V content.

12. The network of claim 10, further comprising a networked DVD system configured to read the A/V content and the display data from the A/V content source, the networked DVD system comprising:
a Program Elementary Stream (PES) to MPEG2 System Level Transport (MP2SLT) process module configured to repackage one or more A/V PES streams; and
an IEEE 1394 interface.

13. The network of claim 12, further comprising:
an A/V decoder for decoding A/V content from the MP2SLT; and
a combiner for combining the decoded A/V content and the generated display on the video monitor.

14. The network of claim 10, wherein the DVDR further comprises a networked DVD data client, through which the navigation module is configured to receive a command from a remote control device.

15. The network of claim 14, wherein the generated display comprises a Graphic User Interface (GUI) including a top menu listing a plurality of A/V contents stored in the digital video source and the display data;
wherein the top menu is configured for one or more users to navigate through the digital video source to select one or more programs to view from the at least one video monitor.

16. A method of receiving one or more programs from a digital video source in a network, wherein each of the one or more programs comprises audio/visual (A/V) content and display data, the method comprising:
obtaining the A/V content from the digital video source in the network; and
obtaining the display data from the digital video source in the network separately from the A/V content.

17. The method of claim 16, further comprising:
generating a display on the one or more sink devices utilizing the obtained display data; and
receiving commands from a control device to enable a user to navigate through the display data to access the one or more programs.

18. The method of claim 16, further comprising:
repackaging one or more Program Elementary Streams (PES) of the A/V content to a MPEG2 System Level Transport (MP2SLT).

19. The method of claim 16, wherein obtaining the A/V content comprises rendering the A/V content isochronously from the digital video source to the one or more sink devices, and wherein obtaining the display data comprises rending the display data asynchronously from the digital video source to the one or more sink devices.

20. The method of claim 16, further comprising moving a plurality of programs from DVD disks to the digital video source in the format of direct copies of disk images.

21. The method of claim 16, further comprising rendering one or more A/V contents and their respective display data to a plurality of sink devices connected to the network.

22. A method of providing data from one or more audio/visual (A/V) source devices to one or more A/V sink devices in a network, comprising:
rendering display data related to A/V content from an A/V source device to one or more sink devices across the network;
obtaining selected display data from one or more of the A/V source devices in the network; and
controlling the presentation module for obtaining the selected display data, to allow one or more users to navigate through the display data to access the A/V content.
